(19) United States
(12) Patent Application Publication
(10) Pub. No.: US 2003/0200545 A1
(43) Pub. Date: Oct. 23, 2003

(54) Program retrieval apparatus, program video processing apparatus and program

(75) Inventor: Kazuhiro Nakada, Tokyo (JP)

Correspondence Address: McGinn & Gibb, PLLC, Suite 200, 8321 Old Courthouse Road, Vienna, VA, 22182-3817, US

(73) Assignee: NEC Corporation, Tokyo (JP)

(21) Appl. No.: 10/419,168

(22) Filed: Apr. 21, 2003

(30) Foreign Application Priority Data
Apr. 23, 2002 (JP) 2002-120146

(51) Int. Cl. G06F 3/00; H04N 5/445; G06F 13/00

(52) U.S. Cl. 725/53; 700/86; 700/87

(57) ABSTRACT

Disclosed are a program retrieval apparatus, a program video processing apparatus and a program which can retrieve a program more accurately. A control section receives an electronic program guide via a tuner or a network interface. As a sequence of characters in the electronic program guide is selected as a keyword through an operational section, the keyword is registered in a memory unit. When receiving an updated electronic program guide, the control section uses the keyword registered in the memory unit and searches programs in the electronic program guide for those programs which match with the keyword. When any program that matches with the keyword is detected, the control section displays a list of all the matched programs on an output section.

### BACKGROUND OF THE INVENTION

1. Field of the Invention

The present invention relates to a program retrieval apparatus which performs a program retrieval process using an electronic program schedule, a program video processing apparatus which performs processes, such as recording of a received program video, and a program which realizes the program retrieval apparatus and program video processing apparatus.

2. Description of the Related Art

Developments have been made on program video processing apparatuses which view and record TV programs or play back recorded programs using computers. The program video processing apparatuses are designed in such a way as to receive programs, such as TV videos, and receive an electronic program guide (EPG) at a given timing, both via a cable or wirelessly.

Electronic program guides available at present provide two weeks of programs at the most, so that programs scheduled more than two weeks ahead cannot be retrieved. When a subscriber does not wish to miss any program which is dated ahead of the latest date registered at the present, e.g., a rebroadcast program whose next broadcasting schedule is unknown, the subscriber should perform searching manually at every given period. This is troublesome and may raise a problem such that the subscriber is likely to forget the searching process.

As a solution to this shortcoming, the invention described in Japanese Patent Laid-Open No. 210379/1998 has been proposed.

This invention disclosed in the Japanese publication detects a specific sequence of characters from character information received wirelessly or via a cable and controls the operation of a TV set or a video recorder/player. The disclosed invention automatically searches checks character information associated with programs available via radio waves or a communication circuit to detect if there is a program corresponding to a pre-registered keyword and notifies a subscriber when there is a target program. This can eliminate the troublesome manual work of searching for a desired program.

As a subscriber can input a keyword quite freely without referring to anything in the invention disclosed in the Japanese publication, however, the keyword may not be a correct program name or person's name. It is very probable that the subscriber does not know if the keyword should contain a symbol or should be given in half-size characters or full-size characters. Therefore, the prior art is disadvantageous in that a keyword suitable for searching is not set, thereby making it difficult to carry out accurate retrieval of a desired program.

Because retrieval is done based on perfect matching of a keyword with a sequence of characters about program information in the prior art, a subscriber may miss receiving or recording the desired program unless the keyword is a correct program name or person's name.

Further, a subscriber is notified of information on a program that has been retrieved every time such retrieval is made, the program information may become a drag.

### SUMMARY OF THE INVENTION

Accordingly, it is an object of the invention to ensure more accurate retrieval of a program.

It is another object of the invention to enable notification of program information at a predetermined timing.

It is a further object of the invention to ensure easy recording and reproduction of a target program.

To achieve the objects, according to one aspect of the invention, there is provided a program retrieval apparatus which. comprises a reception unit which receives an electronic program guide; a keyword storage unit which stores a keyword; a keyword registration unit which extracts a sequence of characters from the electronic program guide received by the reception unit as a keyword and registering the keyword in the keyword storage unit; and retrieval unit which searches sequences of characters in the electronic program guide received by the reception unit for the keyword registered in the keyword registration unit.

The keyword may be a program name or a person's name included in the electronic program guide received by the reception unit.

The retrieval unit may be designed to perform a retrieval process to search the electronic program guide for a program including the keyword and performs a retrieval process to search the electronic program guide for a program including a sequence of characters similar to the keyword.

The program retrieval apparatus may further comprise notification unit which notifies detection of a program including the keyword or a program including a sequence of characters similar to the keyword when the retrieval unit has made the detection.

The program retrieval apparatus may further comprise notification information storage unit which stores the program notified by the notification unit and wherein the notification unit does not give notification about the program stored in the notification information storage unit.

The program retrieval apparatus may further comprise notification information storage unit which stores the program notified by the notification unit and the notification unit may be designed to give notification about the program stored in the notification information storage unit only at a predetermined timing.

According to the second aspect of the invention, there is provided a program video processing apparatus which comprises any of the program retrieval apparatuses described previously; program storage unit; and storage and reproduction unit which stores a program received by the reception unit in the program storage unit and reproducing the program stored in the program storage unit, whereby in case of storing a program notified by the notification unit, the storage and reproduction unit stores a keyword corresponding to the program in association with the program.

The program video processing apparatus may be constructed in such a way that the program retrieval apparatus performs retrieval of a target program from programs stored in the program storage unit based on the keyword associated with the target program and the storage and reproduction unit reproduces the target program retrieved by the program retrieval apparatus from the programs stored in the program storage unit.

According to the third aspect of the invention, there is provided a program which allows a computer to function as keyword registration unit which extracts a sequence of characters from an electronic program guide received by reception unit as a keyword and registering the keyword in keyword storage unit; and retrieval unit which searches sequences of characters in the electronic program guide received by the reception unit for the keyword registered in the keyword registration unit. As the program of the invention is executed on a computer, the computer functions as the keyword registration unit which extracts a sequence of characters from an electronic program guide received by the reception unit as a keyword and registering the keyword in the keyword storage unit; and the retrieval unit which searches sequences of characters in the electronic program guide received by the reception unit for the keyword registered in the keyword registration unit.

The keyword may be a program name or a person's name included in the electronic program guide received by the reception unit.

The program may be designed in such a way that the retrieval unit is allowed to function in such a way as to perform a retrieval process to search the electronic program guide for a program including the keyword and performs a retrieval process to search the electronic program guide for a program including a sequence of characters similar to the keyword.

The program may be designed in such a way that the computer is further allowed to function as notification unit which notifies detection of a program including the keyword or a program including a sequence of characters similar to the keyword when the retrieval unit has made the detection.

The program may be designed so that the notification unit is allowed to function in such a way as not to give notification about a program stored in notification information storage unit.

The program may be designed so that the notification unit is allowed to function in such a way as to give notification about a program stored in notification information storage unit only at a predetermined timing.

Further, the program may be designed in such a way that the computer is further allowed to function as storage and reproduction unit which stores a keyword corresponding to a program notified by the notification unit in association with that program in case of storing the program notified by the notification unit in program storage unit.

Furthermore, the program may be designed so that the storage and reproduction unit is allowed to further function in such a way as to reproduce the target program retrieved by the retrieval unit from the programs stored in the program storage unit.

### BRIEF DESCRIPTION OF THE DRAWINGS

FIG. 1 is a block diagram of a program video processing apparatus according to one embodiment of the invention;

FIG. 2 is a flowchart illustrating a keyword registration process according to the embodiment of the invention;

FIG. 3 is a flowchart illustrating a process at the time of updating an electronic program guide according to the embodiment of the invention;

FIG. 4 is a flowchart illustrating a retrieval process according to the embodiment of the invention;

FIG. 5 is a flowchart illustrating a notified-program determining process according to the embodiment of the invention;

FIGS. 6A and 6B are explanatory diagrams showing the comparison of the retrieval process according to the embodiment of the invention with the conventional retrieval process;

FIG. 7 is a flowchart illustrating a keyword adding process at the time of recording according to the embodiment of the invention; and

FIG. 8 is a flowchart illustrating a playback process for a keyword-attached recorded program according to the embodiment of the invention.

### DETAILED DESCRIPTION OF THE PREFERRED EMBODIMENT

A description will now be given of a program retrieval apparatus, a program video processing apparatus and a program according to one embodiment of the invention by referring to the accompanying drawings.

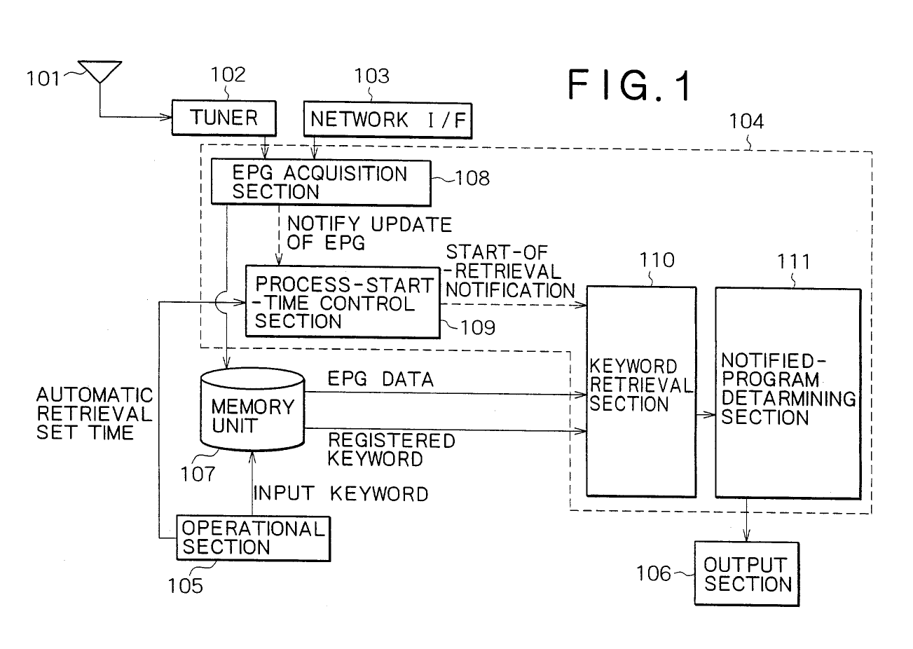

FIG. 1 is a block diagram of a program video processing apparatus according to the embodiment of the invention. In FIG. 1, the program video processing apparatus comprises an antenna 101, a tuner 102, a network interface (I/F) 103 for connection to a network, such as the Internet, a control section 104, an operational section 105, an output section 106 and a memory unit 107 which is comprised of a magnetic disk or a semiconductor memory.

The operational section 105 is comprised of, for example, a keyboard and a mouse. The output section 106 is comprised of, for example, a display section or a portable terminal unit. Through the operational section 105, a keyword is set or a timing (automatic retrieval time) for detecting if there is a program which matches with the keyword and notifying the presence of such a program is set. Information of the notification timing that is set through the operational section 105 is stored in a notification timing memory area (notification timing storage unit) in the memory unit 107.

The control section 104 has an electronic program guide (EPG) acquisition section 108, a process-start-time control section 109, a keyword retrieval section 110 and a notified-program determining section 111.

The EPG acquisition section 108 acquires an electronic program guide (EPG) wirelessly via the antenna 101 and the tuner 102 or over a cable via the network I/F 103, and updates an electronic program guide already stored in the memory unit 107. At the time of updating the electronic program guide, the EPG acquisition section 108 outputs an EPG update notification.

When receiving the EPG update notification from the EPG acquisition section 108, the process-start-time control section 109 transmits a start-of-retrieval notification to the keyword retrieval section 110 at the notification timing set by the operational section 105. In response to the start-of-retrieval notification, the keyword retrieval section 110 executes a process of retrieving an electronic program guide.

The control section 104, the operational section 105, the output section 106 and the memory unit 107 can be constituted by a computer. In this case, the control section 104 is realized by the functions that are provided as a program stored in the memory unit 107 is executed by a central processing unit (CPU).

The control section 104, the operational section 105, the output section 106 and the memory unit 107 constitute a program retrieval apparatus. The antenna 101, the tuner 102, the network I/F 103 and the EPG acquisition section 108 constitute reception unit. The output section 106 and the notified-program determining section 111 constitute notification unit, the keyword retrieval section 110 constitutes retrieval unit and the operational section 105 constitutes keyword registration unit. The control section 104 constitutes the keyword registration unit and storage and reproduction unit.

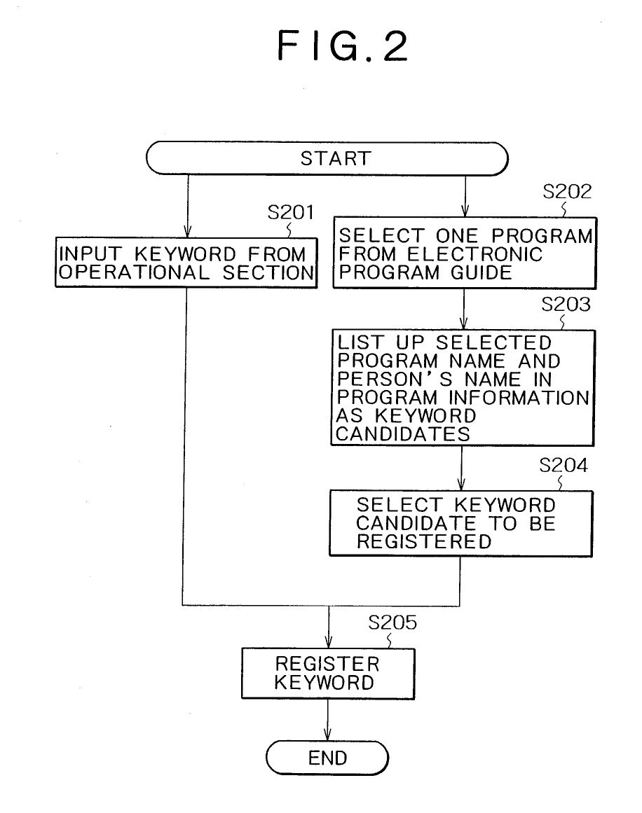

FIG. 2 is a flowchart illustrating the process of the control section 104 at the time a keyword is registered according to the embodiment of the invention. The process is performed as the program prescored in the memory unit 107 is run by the CPU.

There are two keyword registration methods in case where a keyword is registered using an electronic program guide stored in an electronic program guide memory area (electronic program guide storage unit) in the memory unit 107. The methods include a method of registering the keyword as a subscriber selects a sequence of characters from an electronic program guide one at a time using the operational section 105 and a method which allows the control section 104 to automatically extract keyword candidates from the electronic program guide beforehand and allows the subscriber to select a desired one from the candidates.

One example of the method that realizes the automatic keyword candidate extraction uses a predetermined special symbol. In this case, the sender side (e.g., a broadcasting station) of an electronic program guide has added a predetermined special symbol to program names, persons' names, important keywords or the like in program information first and the receiver side (specifically, the control section 104) acquires keyword candidates from the program information based on the symbol. The special symbol may be angle brackets “<” and “>” tagged to a possible keyword, such as “<important keyword>”.

Another example of keyword candidate extraction which does not use such a special symbol is to acquire a program name from the distinctive portion of program information. Specifically, if blank space and “'” come in succession, a sequence of characters which comes before the blank space is considered as a program name.

The keyword registration process according to the embodiment of the invention will be discussed below referring to FIGS. 1 and 2.

In case where a subscriber registers a keyword by selecting a sequence of characters from an electronic program guide one at a time, the subscriber operates the operational section 105 to display the electronic program guide stored in the memory unit 107 on the output section 106 and then operates the operational section 105 in this situation to input a desired keyword by selecting a sequence of characters from an electronic program guide one at a time (step S201). The control section 104 stores the keyword input from the operational section 105 in the keyword memory area (keyword storage unit) in the memory unit 107. The subscriber may input a desired keyword directly through the operational section 105 without selecting it from the electronic program guide.

In case where sequences of characters in an electronic program guide are to be extracted as keyword candidates by the control section 104, the subscriber operates the operational section 105 to select one program from the electronic program guide stored in the electronic program guide storage unit in the memory unit 107 (step S202). The control section 104 lists up the name of the program (program name) selected through the operational section 105 and persons' names (such as the names of characters in the program and the name of director) in information of the program as keyword candidates and displays the list on the output section 106 in the above-described manner (step S203).

As the subscriber selects a desired keyword candidate from the list of keyword candidates by operating the operational section 105 (step S204), the control section 104 stores the selected keyword candidate as a keyword in the keyword storage unit in the memory unit 107 (step S205).

Through the process, the keyword that is desired by the subscriber is registered in the memory unit 107. In case where a keyword is extracted from an electronic program guide, the electronic program guide need not be located in the local memory unit 107 but may be stored in a memory unit (not shown) on the network. For example, the electronic program guide may be one on a WEB site. In this case, the electronic program guide is accessed via the network I/F 103.

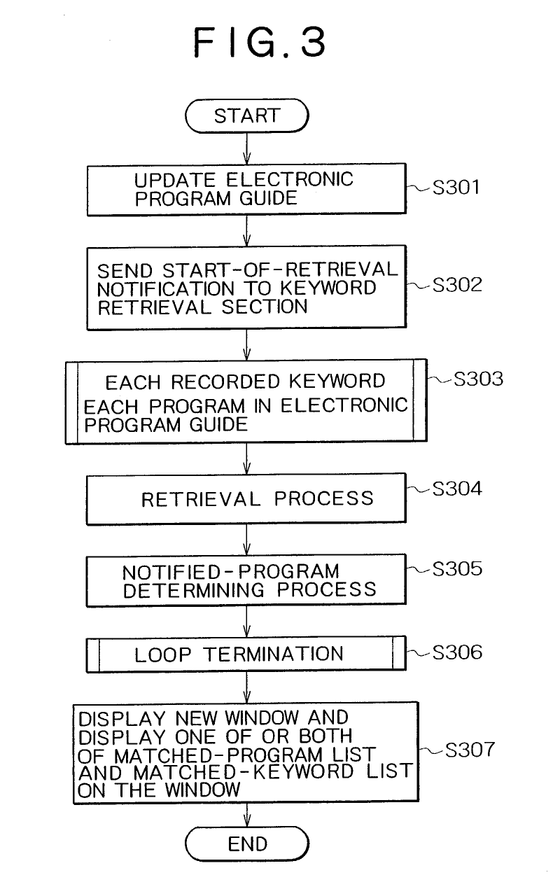

FIG. 3 is a flowchart illustrating the process of the control section 104 at the time of updating an electronic program guide according to the embodiment shown in FIG. 1. This process is executed as the program stored beforehand in the memory unit 107 is run by the CPU.

The process at the time of updating an electronic program guide according to the embodiment of the invention will be discussed below referring to FIGS. 1 and 3.

As the EPG acquisition section 108 receives the updated, latest electronic program guide wirelessly via the antenna 101 and the tuner 102 or over a cable via the network I/F 103, the EPG acquisition section 108 updates an electronic program guide stored in the memory unit 107 with the latest one (step S301) and sends an EPG update notification indicating that the electronic program guide has been updated to the process-start-time control section 109.

In response to the update notification, the process-start-time control section 109 outputs a start-of-retrieval notification to indicate the initiation of retrieval to the keyword retrieval section 110 (step S302).

The keyword retrieval section 110 performs a process, such as retrieval, for each program in the updated electronic program guide by using each keyword registered in the memory unit 107 (steps S303 to S306). That is, the sequence of steps S303 to S306 repeatedly executes a retrieval process of detecting if a program which matches with each keyword is present in the updated electronic program guide (step S304) and a determination process of determining whether or not the program detected in the retrieval process is the one already notified (step S305) for every program using every keyword registered. The retrieval process and the notified-program determining process determining process will be elaborated later.

When the sequence of steps S303 to S306 is finished, the retrieval result is output to the output section 106 (step S307). In step S307, when the output section is a display section, for example, at least one of a list of programs which has matched with the keywords and a list of the matched keywords is displayed. This notifies the subscriber of the retrieval result.

Note that the retrieval result is set by the operational section 105 and is notified at timings stored in the notification timing storage unit which example, the notification timings include the time when a target program is found in the first retrieval process, immediately before broadcasting the program, the time when the electronic program guide is updated and the time when the broadcasting time for the program is changed. The notification may be given only once at each of the timings or the notification timings and the number of times the notification is given may be combined in various ways so that the notification can be given by a predetermined number of times which is designated by the subscriber by combining the timings.

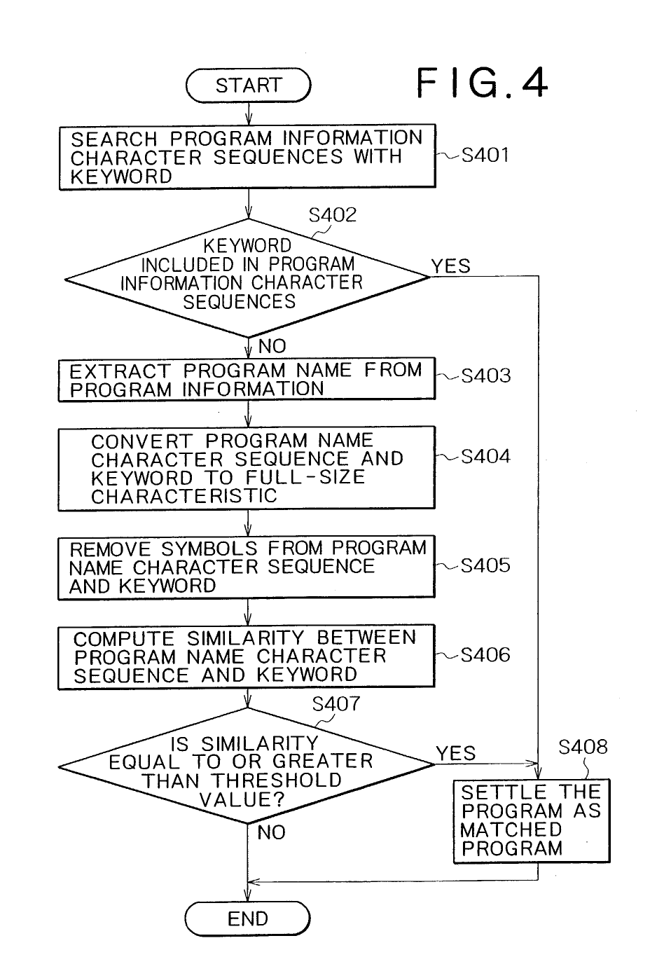

FIG. 4 is a flowchart illustrating the details of the retrieval process (step S304 in FIG. 3) that is carried out in the embodiment shown in FIG. 1. This process is executed as the program stored beforehand in the memory unit 107 is run by the CPU.

In the retrieval process, various retrieval schemes, such as retrieval based on logic operations using a plurality of keywords, are available. For example, the retrieval schemes include a scheme of retrieving individual keywords independently and a scheme of retrieving only a program which includes all the keywords designated. Further, the targets to be retrieved with a keyword can be limited to those which are specified by, for example, a program-name only keyword or a person's-name only keyword. In case of the program-name only keyword, a program name is acquired from program information by the above-described method and is alone treated as the retrieval target.

There are various ways to notify the retrieval result, such as a scheme of using a pop-up display on the display section, a scheme of blinking or changing a specific display icon and a scheme of blinking or changing a part of an application window. Other available schemes include a scheme of giving notification to a portable terminal; specifically, notification is sent by electronic mail to a portable telephone, a notebook type personal computer or the like.

The retrieval process according to the embodiment of the invention will be elaborated below referring to FIGS. 1 and 4.

The keyword retrieval section 110 searches all sequences of characters (program information character sequences: for example, program names or persons' names in the electronic program guide) included in all the programs in the electronic program guide using a keyword stored in the memory unit 107 (step S401) and determines whether or not the keyword is included in the program information character sequences (step S402).

When having determined in step S402 that the keyword is included in the program information character sequences, the keyword retrieval section 110 finishes the process, considering every program containing the keyword as a program which matches with the keyword (matched program) (step S408).

Even when the keyword retrieval section 110 has determined in step S402 that the keyword is not included in the program information character sequences, there is a possibility that retrieval has not been done with the adequate keyword. For example, a subscriber may not know the correct program name or the like at the time of registering a keyword to retrieve program information. Particularly, it seems that a subscriber hardly knows whether a sequence of characters in program information is given in full-size characters or half-size characters or contains symbols, such as “!” and “•”.

To cover the lack of inexperience of the subscriber and execute a more adequate retrieval process, therefore, a fuzzy retrieval process as discussed below is executed.

When the keyword retrieval section 110 has determined in step S402 that the keyword is not included in each program information character sequence, the keyword retrieval section 110 extracts a program name from the program information character sequence first (step S403).

Next, the keyword retrieval section 110 performs steps S404 and S405 to perform retrieval process after converting every sequence of characters to full-size characters and removing symbols, such as “!” and “•”. In step S404, the keyword retrieval section 110 converts the sequence of characters of an extracted program name and the keyword to full-size characters. In step S405, the keyword retrieval section 110 removes symbols other than characters from the sequence of characters of the program name and the keyword converted to full-size characters.

Then, the keyword retrieval section 110 computes the similarity between the symbols-removed program name character sequence and the keyword (step S406).

Next, the keyword retrieval section 110 determines if the similarity between the symbols-removed program name character sequence and the keyword is equal to or greater than a predetermined threshold value to thereby determine whether or not the program is a matched program (step S407).

The computation of the similarity of the sequence of characters is performed, for example, as follows.

(1) The score is calculated by comparing two sequences of characters with each other. When the character sequences are the same, a weight value is changed for each character type. While the score computation is carried out character by character, the score is increased further if a plurality of consecutive sequences of characters have a match.

(2) When characters which have been compared with each other are the same, first, comparison is made again after changing the comparison position in one of or both of sequences of characters. In this case, computation is done to find which sequence of characters, if moved, has a smaller penalty, and the one which is less likely to have a match is shifted and comparison is made again to calculate the score.

(3) After the score is calculated, normalization is performed with the lengths of both sequences of characters.

(4) The value after normalization is the similarity and the greater the value of the similarity is, the more similar both character sequences are.

When the similarity between the program name character sequence and the keyword is equal to or greater than the predetermined threshold value in step S407, the flow goes to step S408 and the program is settled as a matched program. When the similarity between the program name character sequence and the keyword is not equal to or greater than the predetermined threshold value in step S407, on the other hand, it is considered that the program is not a matched program and the flow is terminated.

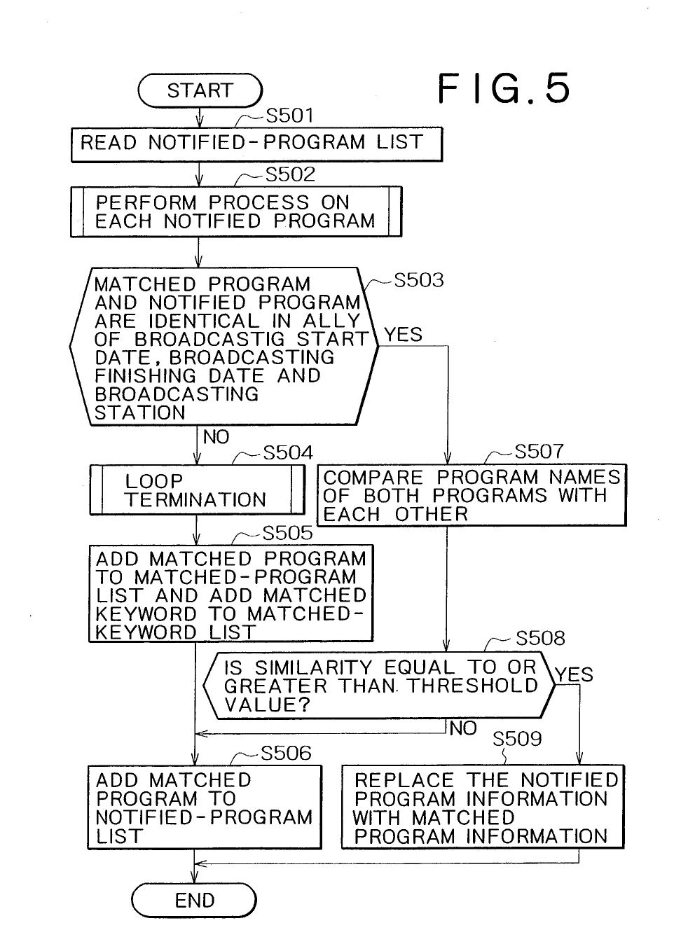

FIG. 5 is a flowchart illustrating the details of the notified-program determining process determining process (step S305 in FIG. 3) that is performed by the embodiment shown in FIG. 1. This process is executed as the program stored in advance in the memory unit 107 is run by the CPU.

The notified-program determining process according to the embodiment of the invention will be described in detail below referring to FIGS. 1 and 5.

First, the notified-program determining section 111 reads a notified-program list stored in the memory unit 107 from the memory unit 107 (step S501). The notified-program list is a list of programs which have been detected in the retrieval processes so far and of which the subscriber has been notified and is stored in a notified-program memory area (notified-program storage unit) in the memory unit 107.

Next, the notified-program determining section 111 executes a sequence of steps S502 to S504 on each notified program. That is, the notified-program determining section 111 determines if the broadcasting start date, the broadcasting end date and the broadcasting station of each matched program detected in the retrieval process step S304 in FIG. 3 are all identical to those of a notified program, respectively (step S503). When they are all identical, the notified-program determining section 111 compares the names of the matched program and the notified program, which are identical in those three parameters, with each other (step S507).

Through the comparison in step S507, it is determined if the similarity between the names of both programs is equal to or greater than a predetermined threshold value (step S508). When it is determined that the similarity between the names of both programs is equal to or greater than the predetermined threshold value in step S508, both programs are determined as the same program and the notified program information is replaced with the matched program information to correct the notified program information to the correct one (step S509). In this case, the matched program is the program that has already been notified and notification to that effect is given to the subscriber at a predetermined timing set through the operational section 105, such as immediately before broadcasting the program (step S307 in FIG. 3).

When it is not determined in step S508 that the similarity between the names of both programs is equal to or greater than the predetermined threshold value, on the other hand, the matched program is added to the notified-program list (step S506). The matched program is an unnotified program and notification to that effect is given to the subscriber at the predetermined timing set through the operational section 105 (step S307 in FIG. 3).

In case where it is determined in step S503 that the matched program and the notified program differ from each other in any of the broadcasting start date, the broadcasting end date and the broadcasting station, on the other hand, the matched program is added to a matched-program list and the matched keyword is added to a matched-keyword list (step S505). Thereafter, the process goes to step S506 where the matched program is added to the notified-program list. The matched program is an unnotified program and notification to that effect is given to the subscriber at the predetermined timing set through the operational section 105 (step S307 in FIG. 3).

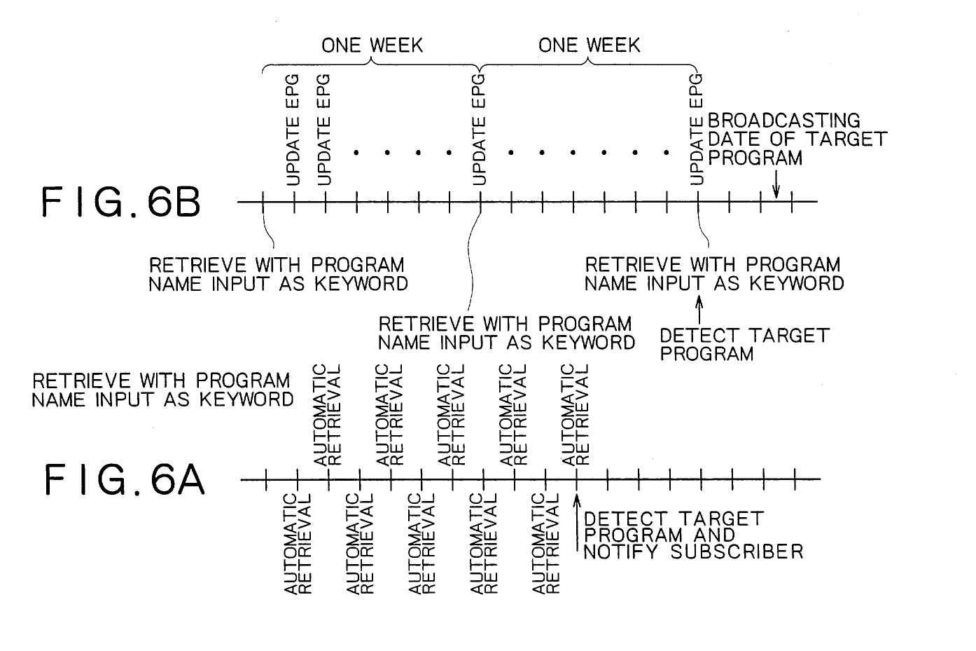

FIGS. 6A and 6B are diagrams showing the comparison of the retrieval process according to the embodiment of the invention with the conventional retrieval process and each show the time flow until a target program is found. FIG. 6A illustrates the retrieval process according to the embodiment while FIG. 6B illustrates the conventional retrieval process. It is premised on that an electronic program guide is to be updated every day and the electronic program guide available covers programs for one week ahead from the current date or automatic retrieval is executed when the electronic program guide is updated.

Because data of an electronic program guide is completely changed in one week in the case of the conventional retrieval process, it is necessary to perform retrieval at least every week in order not to miss a target program. According to the embodiment of the invention, first, a subscriber registers a keyword after which retrieval is carried out automatically every time the electronic program guide is updated and the subscriber is notified when a target program is found.

Comparing both cases from the viewpoint of the number of operations done by the subscriber, the conventional retrieval process requires a retrieval operation every week, whereas the embodiment requires no operation once the keyword is registered. In the example of FIGS. 6A and 6B, the target program is broadcast in about two and a half weeks from the beginning. If the broadcasting date of the target program is half a year ahead, the conventional needs to repeat the operation about thirty times, whereas the embodiment of the invention can eliminate the tiresome operations.

In case of searching for a program or the like whose broadcasting schedule is unknown, the conventional method necessitates that the subscriber should perform retrieval process manually every given period, whereas the subscriber needs only one operation in the embodiment. It is also possible to avoid a risk of missing a program due to the subscriber's forgetting the otherwise required operation.

As predetermined character sequence information (e.g., a program name or person's name) can be extracted from program information and registered as a keyword, the possibility of retrieving a target program with the wrong program name or the like can be reduced.

At the time of retrieving a target program, the program can be sought out by carrying out a fuzzy retrieval process, such as conversion of a sequence of characters to full-size characters and removal of symbols even if the subscriber does not know the correct program name or person's name.

Further, it is possible to seek which is closer to the result that is demanded by the subscriber, by narrowing down the retrieval target of each keyword, such as a person's name.

As information of a program once notified is saved, the notification timing can be controlled.

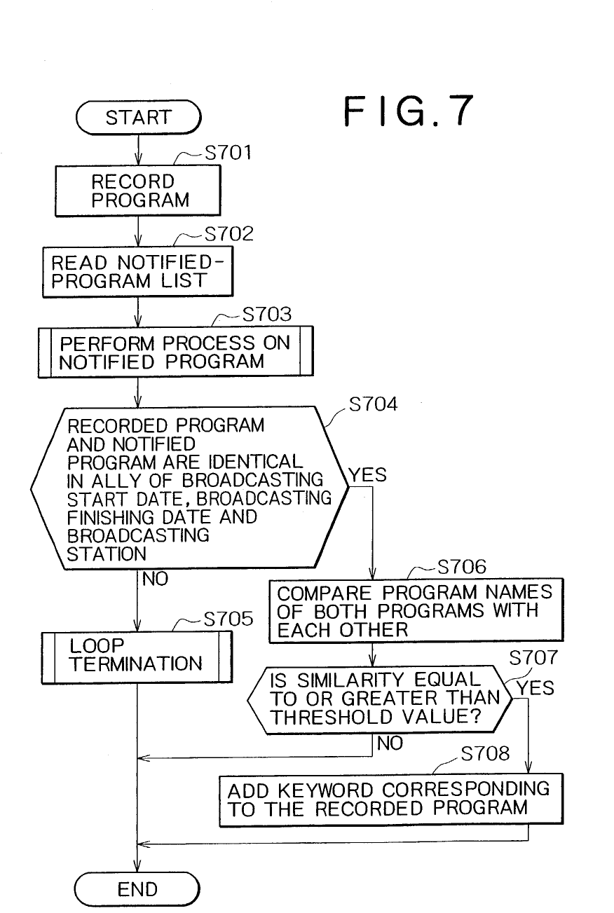

FIG. 7 is a flowchart illustrating a keyword adding process at the time of recording according to the embodiment shown in FIG. 1. This process is executed as the program stored beforehand in the memory unit 107 is run by the CPU.

The following will discuss the keyword adding process according to the embodiment of the invention by referring to FIGS. 1 and 7. The control section 104 functions as storage and reproduction unit which records a received program and reproduces the recorded program.

The control section 104 automatically records a program of which the subscriber is notified in the program memory area (program storage unit) in the memory unit 107 (step S701). Recording of a program is accomplished by determining when the broadcasting time for a notified program has come by referring to an electronic program guide stored in the memory unit 107 and storing a program, received via the antenna 101 and the tuner 102, in the memory unit 107. It is to be noted that switching the channel for a program to be received is executed as the control section 104 controls the tuner 102.

Next, the control section 104 reads the notified-program list from the memory unit 107 (step S702). The notified-program list is a list of programs which have been detected in the retrieval processes so far and of which the subscriber has been notified.

Next, the control section 104 executes a sequence of steps S703 to S704 on each notified program. That is, the control section 104 determines if the broadcasting start date, the broadcasting end date and the broadcasting station of the program recorded (recorded program) in step S701 are all identical to those of a notified program, respectively (step S704). When they are all identical, the control section 104 compares the names of the recorded program and the notified program with each other (step S706).

Through the comparison in step S706, the control section 104 determines if the similarity between the names of both programs is equal to or greater than a predetermined threshold value (step S707). When it is determined that the similarity between the names of both programs is equal to or greater than the predetermined threshold value in step S707, a keyword corresponding to the recorded program is stored in the program storage unit in the memory unit 107 in association with the recorded program (step S708). When it is not determined in step S707 that the similarity between the names of both programs is equal to or greater than the predetermined threshold value, the process is terminated without carrying out the keyword adding process.

In case where the notified program is recorded, therefore, the keyword is stored in the memory unit 107 in association with the recorded program. In case where a program which has not been notified is recorded (for example, in case where the subscriber has recorded the program manually), on the other hand, the keyword associated with the recorded program is not stored.

It is therefore possible to manage recorded programs for each affixed keyword. For example, it becomes possible to separate save positions in accordance with the keyword or display a list of recorded programs sorted out keyword by keyword when the list is displayed. As will be discussed later, it is possible to automatically link and reproduce those programs which have the same keyword.

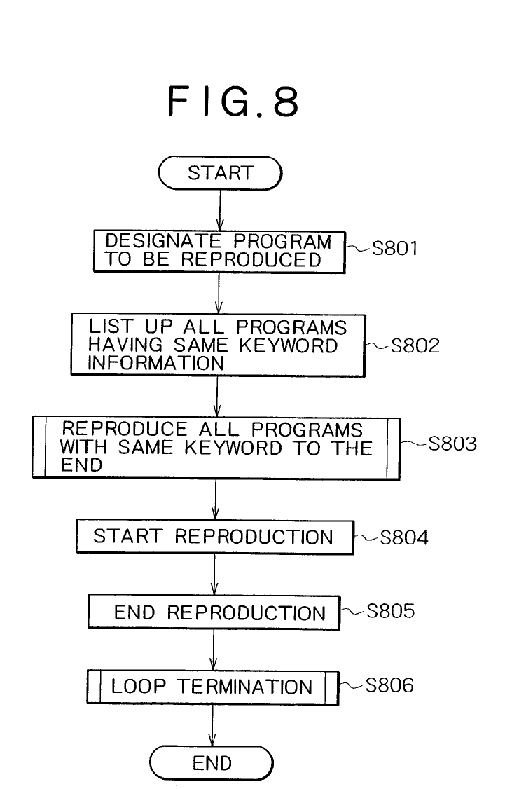

FIG. 8 is a flowchart illustrating a playback process for a recorded program (keyword-attached recorded program) to which has a keyword has been affixed at the time of recording according to the embodiment shown in FIG. 1. This process is executed as the program stored beforehand in the memory unit 107 is run by the CPU.

Referring to FIGS. 1 and 8, the reproduction process for keyword-attached recorded program according to the embodiment of the invention will be described in detail below.

First, the subscriber designates a recorded program to be reproduced by using the operational section 105 (step S801). The designation of the recorded program is done by selecting a keyword stored in the memory unit 107 by operating the operational section 105.

The control section 104 searches keyword-attached recorded programs in the memory unit 107 and lists up all the recorded programs to which the keyword is affixed (step S802).

The control section 104 performs a sequence of steps S803 to S806 on each recorded program listed. That is, the control section 104 starts reproducing each listed recorded program (step S804) and finishes the reproduction (step S805).

This can allow recorded programs affixed with the same keyword to be automatically reproduced consecutively or to be automatically linked and reproduced.

As described above, a program retrieval apparatus according to the embodiment of the invention comprises reception unit which receives an electronic program guide; keyword storage unit (memory unit 107) which stores a keyword; keyword registration unit (operational section 105, control section 104) which extracts a sequence of characters from the electronic program guide received by the reception unit as a keyword and registering the keyword in the keyword storage unit; and retrieval unit (keyword retrieval section 110) which searches sequences of characters in the electronic program guide received by the reception unit for the keyword registered in the keyword registration unit. It is therefore possible to retrieve a program more accurately. The embodiment brings about an advantage such that program information can be notified at a predetermined timing.

A program video processing apparatus according to the embodiment of the invention comprises the aforementioned program retrieval apparatus; program storage unit (memory unit 107); and storage and reproduction unit (control section 104) which stores a program received by the reception unit in the program storage unit and reproducing the program stored in the program storage unit, whereby in case of storing a program notified by the notification unit, the storage and reproduction unit stores a keyword corresponding to the program in association with the program. It is therefore possible record and reproduce a target program easily.

A program according to the embodiment of the invention is designed to allow a computer to function as keyword registration unit which extracts a sequence of characters from an electronic program guide received by reception unit as a keyword and registering the keyword in keyword storage unit; and retrieval unit which searches sequences of characters in the electronic program guide received by the reception unit for the keyword registered in the keyword registration unit. As this program is executed by the computer, the program retrieval apparatus and the program video processing apparatus can be constituted.

The program retrieval apparatus according to the invention can ensure more accurate retrieval of a program. The program retrieval apparatus can also notify program information at a predetermined timing.

The program video processing apparatus according to the invention can ensure easy recording and reproduction of a target program.

The program retrieval apparatus and the program video processing apparatus can be realized as the program according to the invention is executed by a computer.

What is claimed is:

1. A program retrieval apparatus comprising:
a reception unit which receives an electronic program guide;
a keyword storage unit which stores a keyword;
a keyword registration unit which extracts a sequence of characters from said electronic program guide received by said reception unit as a keyword and registering said keyword in said keyword storage unit; and
a retrieval unit which searches sequences of characters in said electronic program guide received by said reception unit for said keyword registered in said keyword registration unit.

2. The program retrieval apparatus according to claim 1, wherein said keyword is a program name or a person's name included in said electronic program guide received by said reception unit.

3. The program retrieval apparatus according to claim 1, wherein said retrieval unit performs a retrieval process to search said electronic program guide for a program including said keyword and performs a retrieval process to search said electronic program guide for a program including a sequence of characters similar to said keyword.

4. The program retrieval apparatus according to claim 1, further comprising a notification unit which notifies detection of a program including said keyword or a program including a sequence of characters similar to said keyword when said retrieval unit has made the detection.

5. The program retrieval apparatus according to claim 4, further comprising a notification information storage unit which stores said program notified by said notification unit and wherein said notification unit does not give notification about said program stored in said notification information storage unit.

6. The program retrieval apparatus according to claim 4, further comprising a notification information storage unit which stores said program notified by said notification unit and wherein said notification unit gives notification about said program stored in said notification information storage unit only at a predetermined timing.

7. A program video processing apparatus comprising:
a program retrieval apparatus as recited in claim 4;
program storage unit; and
storage and reproduction unit which stores a program received by said reception unit in said program storage unit and reproducing said program stored in said program storage unit, whereby in case of storing a program notified by said notification unit, said storage and reproduction unit stores a keyword corresponding to said program in association with said program.

8. The program video processing apparatus according to claim 7, wherein said program retrieval apparatus performs retrieval of a target program from programs stored in said program storage unit based on said keyword associated with said target program and said storage and reproduction unit reproduces said target program retrieved by said program retrieval apparatus from said programs stored in said program storage unit.

9. A program for allowing a computer to function as:
a keyword registration unit which extracts a sequence of characters from an electronic program guide received by a reception unit as a keyword and registering said keyword in a keyword storage unit; and
a retrieval unit which searches sequences of characters in said electronic program guide received by said reception unit for said keyword registered in said keyword registration unit.

10. The program according to claim 9, wherein said keyword is a program name or a person's name included in said electronic program guide received by said reception unit.

11. The program according to claim 9, wherein said retrieval unit is allowed to function in such a way as to perform a retrieval process to search said electronic program guide for a program including said keyword and performs a retrieval process to search said electronic program guide for a program including a sequence of characters similar to said keyword.

12. The program according to claim 9, wherein said computer is further allowed to function as a notification unit which notifies detection of a program including said keyword or a program including a sequence of characters similar to said keyword when said retrieval unit has made the detection.

13. The program according to claim 12, wherein said notification unit is allowed to function in such a way as not to give notification about a program stored in notification information storage unit.

14. The program according to claim 12, wherein said notification unit is allowed to function in such a way as to give notification about a program stored in notification information storage unit only at a predetermined timing.

15. The program according to claim 12, wherein said computer is further allowed to function as a storage and reproduction unit which stores a keyword corresponding to a program notified by said notification unit in association with that program in case of storing said program notified by said notification unit in program storage unit.

16. The program according to claim 15, wherein said storage and reproduction unit is allowed to further function in such a way as to reproduce said target program retrieved by said retrieval unit from said programs stored in said program storage unit.
